(19) United States
(12) Patent Application Publication
(10) Pub. No.: US 2026/0203809 A1
(43) Pub. Date: Jul. 16, 2026

(54) BANKING COMPLIANCE MONITORING ACROSS USER BANK ACCOUNTS

(71) Applicant: MOTOROLA MOBILITY LLC, WILMINGTON, DE (US)

(72) Inventors: AMIT KUMAR AGRAWAL, BANGALORE (IN); NAKUL PATEL, NAGPUR (IN); VIJAYPRAKASH IDLUR, BANGALORE (IN)

(21) Appl. No.: 19/018,872

(22) Filed: Jan. 13, 2025

(51) Int. Cl. G06Q 40/02

(52) U.S. Cl. CPC G06Q 40/02

(57) ABSTRACT

A method provides techniques for monitoring banking compliance across user bank accounts and financial/banking institutions. Transactional access to banking institutions at which a user has at least one account is maintained on an electronic device. The banking institutions include at least a first banking institution and a second banking institution. A compliance status check for each banking institution among the banking institutions is performed. In response to determining a possible non-compliance exists, a non-compliance alert message is rendered and presented on the electronic device that indicates each banking account or institution among the banking accounts and/or institutions for which a possible non-compliance exists. Mitigation measures are presented and/or initiated that trigger mitigation of the non-compliance.

### BACKGROUND

### 1. Technical Field

The present disclosure generally relates to banking transactions with electronic devices, and more specifically to electronic devices utilized for completing banking transactions.

### 2. Description of the Related Art

Banking regulations are essential for ensuring the stability, security, and integrity of the financial system. These regulations establish rules for both financial institutions and customers, promoting trust, transparency, and fairness in banking operations. Institutional rules and regulations can help prevent the misuse of banking systems for illegal activities, enhancing global security and protecting the economy from criminal exploitation.

Banking customers are also subject to rules and regulations. Rules such as minimum balance requirements or overdraft policies encourage responsible financial behavior and ensure that banking services remain sustainable for the institution and equitable for other customers. Thus, banking regulations are important for maintaining a balanced relationship between financial institutions and customers. These regulations serve to create a framework that supports economic stability, protects consumers, and fosters a trustworthy and equitable banking environment.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A presents a functional block diagram of example components of an electronic device in a communication environment and having hardware and software components that enable the features of the present disclosure to be advantageously implemented, according to one or more embodiments;

FIG. 1B is an additional block diagram representation of the electronic device of FIG. 1A presenting additional components, including components for wireless communications with other devices, according to one or more embodiments;

FIG. 2 shows an exemplary environment including multiple financial institutional application servers, with account information stored therein, according to one or more embodiments;

FIG. 3 illustrates an exemplary user interface indicating account non-compliance due to a funding source violation, according to one or more embodiments;

FIG. 4 illustrates an exemplary user interface for suggesting an alternate account to avoid a funding source violation, according to one or more embodiments;

FIG. 5 illustrates an exemplary user interface indicating account non-compliance due to a minimum balance violation, according to one or more embodiments;

FIG. 6 illustrates an exemplary user interface for balance transfer to transition an account with a balance below a minimum threshold to a compliant state, according to one or more embodiments;

FIG. 7 illustrates an exemplary user interface indicating account non-compliance due to a transaction limit violation, according to one or more embodiments;

FIG. 8 illustrates an exemplary user interface for suggesting an alternate account to avoid a transaction limit violation, according to one or more embodiments;

FIG. 9 illustrates an exemplary user interface for warning a user about institutional non-compliance, according to one or more embodiments;

FIG. 10 illustrates an exemplary user interface for suggesting an alternate account to avoid institutional non-compliance, according to one or more embodiments;

FIG. 11 illustrates an exemplary user interface for warning a user about an approaching Know-Your-Customer (KYC) deadline, according to one or more embodiments;

FIG. 12 depicts a flowchart of a computer-implemented method for banking compliance, according to one or more embodiments; and

FIG. 13 depicts a flowchart of a computer-implemented method for additional embodiments for banking compliance, according to one or more embodiments.

### DETAILED DESCRIPTION

According to aspects of the present disclosure, an electronic device, a method, and a computer program product provide techniques for monitoring banking compliance across multiple user accounts. The trend of increased access to online banking has empowered banks and users alike. Digital (online) banking enables both traditional banks as well as emerging fintech companies to offer bank accounts with unprecedented ease, which has resulted in users now having more than 3 bank accounts on average. This increase in institutions and accounts has created intense competition that can lead to rushed due diligence, resulting in the potential for non-compliance situations. For users, managing multiple accounts can make it difficult to track activity and potential non-compliance issues. Additionally, monitoring institutional compliance can be burdensome for end users. Moreover, noncompliance, resulting from either user error or institutional error, can severely impact end users with problems such as loss of account access and/or frozen funds, and/or disruption of connected operations such as bill and loan payments, which can lead to potential penalties, negative impact to credit score, and other potential adverse impact for/to the user.

The disclosed embodiments address the aforementioned issues by monitoring compliance across the different accounts and institutions of a user. When non-compliance or potential non-compliance is detected, disclosed embodiments provide alerts and/or recommendations for avoiding the adverse impacts of banking non-compliance. The recommendations can include using a different account for a transaction, transferring funds from one account to another, and so on. Moreover, disclosed embodiments can scrape information from various websites and/or other sources, to detect possible institutional non-compliance. Upon detecting possible institutional non-compliance, disclosed embodiments can alert users to the possible institutional non-compliance, giving users advanced notice to take mitigative steps such as transferring funds to another institution.

According to one aspect, banking compliance is monitored across user bank accounts. Transactional access to banking institutions at which a user has at least one account is maintained on an electronic device. The banking institutions include at least a first banking institution and a second banking institution. A compliance status check for each banking institution among the plurality of banking institutions is performed. In response to determining a possible non-compliance exists from at least one compliance status check, a non-compliance alert message is rendered and presented on the electronic device. The non-compliance alert message indicates each banking institution among the plurality of banking institutions for which a possible non-compliance exists.

One or more embodiments can provide an electronic device that includes: a display; a communications subsystem enabling the electronic device to communicatively connect to a network comprising a plurality of second electronic devices; a memory having stored thereon a banking compliance evaluation (BCE) module; and at least one processor coupled to the display, the communications subsystem, and the memory and which processes program code of the BCE module. The at least one processor is configured to cause the electronic device to: maintain transactional access to a plurality of banking institutions at which a user has at least one account, the plurality of banking institutions comprising at least a first banking institution and a second banking institution; perform a compliance status check for each banking institution among the plurality of banking institutions; and in response to determining a possible non-compliance exists from at least one compliance status check, render and present a non-compliance alert message that indicates each banking institution among the plurality of banking institutions for which a possible non-compliance exists.

One or more embodiments can provide a method that includes maintaining, on an electronic device comprising a display, transactional access to a plurality of banking institutions at which a user has at least one account, the plurality of banking institutions comprising at least a first banking institution and a second banking institution. The method includes: performing a compliance status check for each banking institution among the plurality of banking institutions; and in response to determining a possible non-compliance exists from at least one compliance status check, rendering and presenting a non-compliance alert message that indicates each banking institution among the plurality of banking institutions for which a possible non-compliance exists.

Further embodiments can provide a computer program product including: a non-transitory computer readable medium; and program code on the computer readable medium that when processed by a processor of an electronic device configures the processor to perform functions of the above-described method.

The above descriptions contain simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent in the following detailed description.

Each of the above and below described features and functions of the various different aspects, which are presented as operations performed by the processor(s) of the communication/electronic devices are also described as features and functions provided by a plurality of corresponding methods and computer program products, within the various different embodiments presented herein. In the embodiments presented as computer program products, the computer program product includes a non-transitory computer readable storage device having program instructions or code stored thereon, and configuring the electronic device and/or host electronic device to complete the functionality of a respective one of the above-described processes when the program instructions or code are processed by at least one processor of the corresponding electronic/communication device, such as is described above.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, “some embodiments”, or “one or more embodiments” are intended to indicate that a particular feature, structure, or characteristic described in connection with the embodiment is included in at least one implementation (embodiment) of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not for other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element (e.g., a person or a device) from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

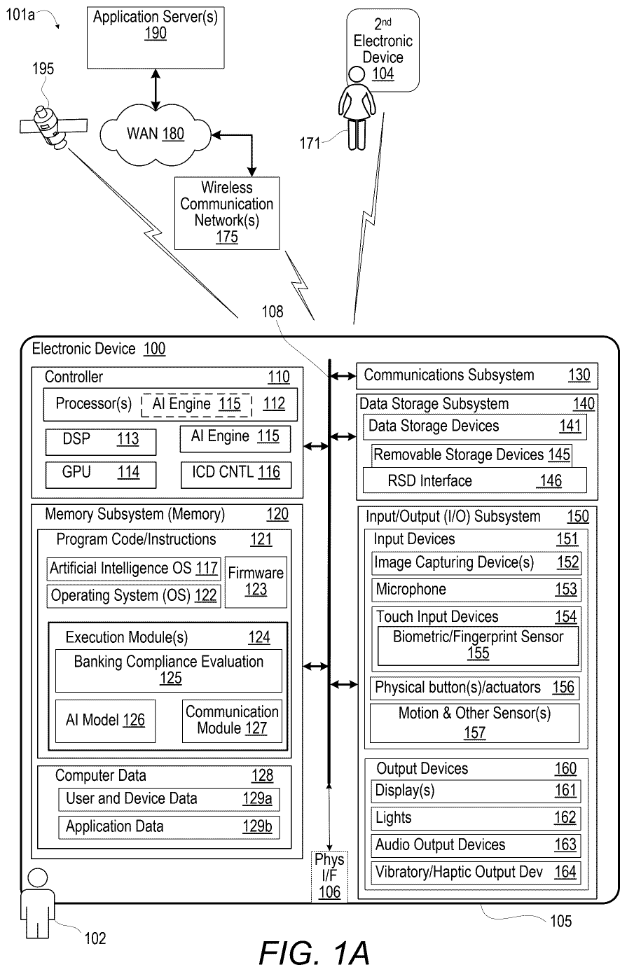

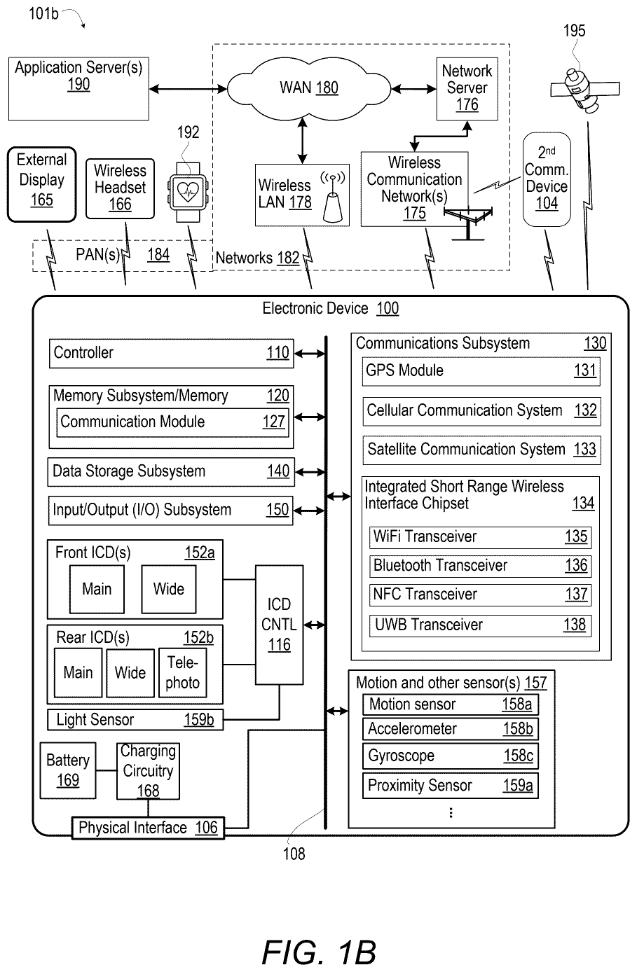

Those of ordinary skill in the art will appreciate that the hardware components and basic configuration depicted in the following figures may vary. For example, the illustrative components within electronic device 100 (FIG. 1A-1B) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure. Throughout this disclosure, the terms ‘electronic device’, ‘communication device’, and ‘electronic communication device’ may be used interchangeably, and may refer to devices such as smartphones, tablet computers, and/or other computing/communication devices.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

Referring now to the figures and beginning with FIG. 1A, there is illustrated a block diagram of an example electronic device 100 in communication environment 101a and having hardware and software components, which enable the features of the present disclosure to be advantageously implemented, according to one or more embodiments.

Examples of electronic device 100 can include, but are not limited to, mobile devices, a notebook computer, a mobile phone, a smart phone, a digital camera with enhanced processing capabilities, a smart watch, a tablet computer, and other types of electronic devices. For purposes of this disclosure, electronic device 100 is assumed to be a communication device that can be used to engage in a voice and/or video call with a second communication device. Electronic device 100 can therefore be interchangeably referred to herein as communication device 100.

Electronic device 100 generally includes controller 110, memory (or memory subsystem) 120, communication subsystem 130, data storage subsystem 140, input/output subsystem 150, all contained within or extended from an exterior surface of device housing 105. Controller 110 is shown communicatively connected/coupled via system interlink 108 with each of the subsystems 120, 130, 140, and 150, and is directly or indirectly connected with the individual components within each subsystem 120, 130, 140, and 150. System interlink 108 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components.

Controller 110 includes processor 112, which includes one or more central processing units (CPUs) or data processors. Processor 112 performs many of the features of controller 110 and references to features performed by controller 110 can be interchangeably referred to herein as features of processor 112, and vice-versa. In some embodiments, the various functions associated with controller 110 are integrated into processor 112, and accordingly, references made herein to controller and/or processor are understood to refer to one or both components as providing a single management component within the electronic device 100. For simplicity in describing the features of the electronic device 100, the operational functions provided by one or more of operational components within controller 110, including those provided by processor 112 are collectively described as being performed by controller 110. Collectively, components integrated within controller 110 support computing, classifying, processing, transmitting and receiving of data and information, and presenting of graphical and photographic images within a display.

As illustrated, controller 110 can also include one or more digital signal processors 113 graphics processing units (GPUs) 114, artificial intelligence (AI) engine 115, and image capturing device (ICD) controller 116. In some embodiments, the functionality of each of these additional processing components can be integrated with processor(s) 112. For example, processor 112 can, in some embodiments, include dedicated AI engine 115. Processor 112 can further include other processors such as auxiliary processor(s) that may act as a low power consumption, always-on sensor hub for physical sensors.

Controller 110 manages, and in some instances directly controls, the various functions and/or operations of electronic device 100. These functions and/or operations include, but are not limited to including, application data processing, communication, location and navigation tasks, image processing, and signal processing. In one or more alternate embodiments, electronic device 100 may use hardware component equivalents for application data processing and signal processing. For example, electronic device 100 may use special purpose hardware, dedicated processors, general purpose computers, microprocessor-based computers, micro-controllers, optical computers, analog computers, dedicated processors and/or dedicated hard-wired logic. Controller 110 can, in some embodiments, also include a hardware acceleration (HA) unit, which can establish direct memory access (DMA) sessions to route network traffic to various elements within electronic device 100 without direct involvement from processor 112 and/or a device operating system 122. Operating system 122 may include or be augmented by device AI operating system (OS) 117 that can include native support for AI-specific hardware such as Neural Processing Units (NPUs) or Tensor Processing Units (TPUs) to optimize performance for AI tasks such as machine learning inference and training.

Memory subsystem (or memory) 120 may include a combination of volatile and non-volatile memory, such as random-access memory (RAM) and read-only memory (ROM). Memory subsystem 120 stores instruction or program code 121 for execution by processor 112 to configure processor 112 (and more generally electronic device 100) to provide the operational functions and features described herein. Instructions/program code 121 (or program code 121 for short) includes instructions for an operating system (OS) 122, firmware 123, such as basic input/output system (BIOS) or Uniform Extensible Firmware Interface (UEFI). Program code 121 includes execution module(s) 124 that collectively provides the various features of the disclosure. Execution module(s) 124 include, without limitation, banking compliance evaluation (BCE) module 125, which provides the features and operating functionality of the disclosed embodiments when the corresponding program instructions of banking compliance evaluation (BCE) module 125 are processed by/within processor 112/controller 110.

Execution modules 124 further includes AI model(s) 126. In one or more embodiments, processor 112 can utilize AI models 126 to provide AI functionality of processor-integrated AI engine 115. In other embodiments, AI models 126 are directly utilized by AI engine 115. In one or more embodiments, AI model(s) 126 is integrated as a sub-module within BCE module 125 and is trained to support AI features of BCE module 125. AI model(s) 126 may include an artificial neural network, a decision tree, a support vector machine, Hidden Markov model, linear regression, logistic regression, Bayesian networks, and so forth. AI model(s) 126 can be individually trained to perform specific tasks and can be arranged in different sets of AI models to generate different types of output. Training of AI model(s) 126 is the process by which AI models are trained to perform specific tasks or achieve certain objectives. The training involves providing the model with a large amount of data and allowing the model to learn from patterns and relationships within that data.

Each of the above-introduced module(s) and/or application(s) provides program instructions/code that are processed by processor 112 and which configures processor 112 (and/or controller 110) and/or other operational components of electronic device 100 to cause the electronic device 100 to perform specific operations and functions, as described herein. Descriptive names assigned to these modules add no functionality and are provided solely to assist in identifying the underlying features performed by processing the different modules. For example, BCE module 125 can include program instructions that cause or configure processor 112 to cause electronic device 100 to monitor financial accounts and financial institutions for non-compliance and/or potential non-compliance. Other features provided by BCE module 125 are described in further detail throughout this disclosure.

Program code 121 can further include instructions/code for other applications (not shown) providing different features of/within electronic device 100. In one or more embodiments, program code 121 may be integrated into a distinct chipset or hardware module as firmware that operates separately from other executable program code. Portions of program code 121 may be incorporated into different hardware components that operate in a distributed or collaborative manner.

Memory subsystem 120 also includes computer data 128. During execution of program code 121, processor 112 may access, use, generate, modify, store, or communicate computer data 128, such as user and device data 129a and application data 129b. Computer data 128 may incorporate “data” that originated as raw, real-world “analog” information that consists of basic facts and figures. Computer data 128 includes different forms of data, such as numerical data, images, coding, notes, and financial data, as well as data presenting video, graphics, text, and images. Computer data 128 may originate at electronic device 100 or may be retrieved from a remote device via communications subsystem 130. Electronic device 100 may store, modify, present, or transmit computer data 128.

Communications subsystem 130 includes various components that enable electronic device 100 to communicate with external communication networks and other devices, such as second electronic device 104 and application server(s) 190, etc., via communications subsystem 130. According to one or more embodiments, communication module 127 presented within program code 121 includes instructions supporting the use of communications subsystem 130 to establish communication interfaces enabling communication by electronic device 100 with these external networks and devices.

Data storage subsystem 140 of electronic device 100 includes data storage device(s) 141. Controller 110 is communicatively connected, via system interlink 108, to data storage device(s) 141. Data storage subsystem 140 provides stored versions of program code 121 and computer data 128 on nonvolatile storage that is accessible by controller 110. The program code 121 can be loaded into memory 120 for execution/processing by controller 110. In one or more embodiments, data storage device(s) 141 can include hard disk drives (HDDs), optical disk drives, and/or solid-state drives (SSDs), etc.

Data storage subsystem 140 of electronic device 100 can include removable storage device(s) (RSD(s)) 145, which is received in RSD interface 146. Controller 110 is communicatively connected to RSD 145, via system interlink 108 through RSD interface 146. In one or more embodiments, RSD 145 is a non-transitory computer program product or computer readable storage device that stores program code and associated data, including a copy of BCE module 125 and AI model(s) 126, which may be executed by a processor associated with a user device, such as electronic device 100. Controller 110 can access data storage device(s) 141 or RSD(s) 145 to provision electronic device 100 with stored program code 121 and computer data 128 that, when executed/processed by processor 112, the program code configures processor 112 and/or more generally electronic device 100, to provide the various functions described herein.

I/O subsystem 150 includes input devices 151 such as, but not limited to, image capturing device(s) (ICDs) 152, microphone 153, and touch input devices 154 (e.g., touch screens, keys, or buttons) for use by a user to interface with electronic device 100. Touch input devices 154 can include a biometric/fingerprint sensor 155 for biometric input. Biometric/fingerprint sensor 155 can be used to read/receive biometric data, such as fingerprints, to identify or authenticate a user. In some embodiments, the biometric sensor 155 can supplement an ICD (camera), which captures images for user detection/identification via facial recognition.

Input devices 151 may include physical buttons/actuators 156 that can be located on a periphery of the device housing 105. Physical buttons/actuators 156 may provide controls for volume, power, and ICDs 152. Microphone 153 can also be referred to as an audio input device. In some embodiments, microphone 153 may be used for identifying a user via voiceprint, voice recognition, and/or other suitable techniques. Input devices 151 can also include one or more motion or other sensor(s) 157, which are further defined in the FIG. 1B description which follows.

With reference to FIG. 1B, as illustrated, motion and other sensor(s) 157 of electronic device 100 include, but are not limited to, one or more motion sensor(s) 158a, one or more accelerometers 158b, one or more gyroscopes 158c, and proximity sensor 159a, etc. Motion sensor(s) 158a detect movement of electronic device 100 and provide motion data to processor 112 indicating the spatial orientation, position and movement of electronic device 100. Accelerometers 158b measure linear acceleration of movement of electronic device 100 in multiple axes (X, Y and Z). For example, accelerometers 158b can include three accelerometers, where one accelerometer measures linear acceleration in the X axis, one accelerometer measures linear acceleration in the Y axis, and one accelerometer measures linear acceleration in the Z axis. Accelerometers 158b can be used to calculate the orientation/position of electronic device 100 relative to the earth and can also be referred to as a gravity sensor. Gyroscope 158c measures rotation or angular rotational velocity of electronic device 100. Proximity sensor 159a senses the presence of nearby objects. In one embodiment, proximity sensor 159a can be an infrared (IR) sensor that detects the presence of a nearby object, such as when electronic device 100 is in a pocket of a user. Electronic device 100 can also include one or more light sensors 159b, which detects the luminance and/or intensity (i.e., the amount) of ambient light surrounding the electronic device 100.

Referring again to FIG. 1A, I/O subsystem 150 includes output devices 160 such as, but not limited to, display(s) 161, lights 162, audio output devices 163, and vibratory and/or haptic output devices 164. In one or more embodiments, electronic device 100 includes an integrated display 161 which incorporates a tactile, touch screen interface that can receive a user's tactile/touch input. As a touch screen device, integrated display 161 allows a user to provide input to and/or to control electronic device 100 by touching features within a user interface presented on integrated display 161. Tactile, touch input device 154 can include a touch screen interface. The touch screen interface can include one or more virtual buttons or selectable affordances. In one or more embodiments, when a user 102 applies a finger or stylus on the touch screen interface (154) in the region demarked by the virtual button, the touch of the region causes the processor 112 to execute code to implement a function associated with the virtual button. In some implementations, integrated display 161 is integrated into a front surface of electronic device housing 105 along with front image capturing devices (not specifically shown), while the higher quality ICDs are located on a rear surface of device housing 105. Other embodiments provide multiple integrated displays within electronic device 100 and references to display(s) 161 are assumed to refer to one or all of these multiple integrated displays.

Vibration/haptic output device 164 can cause electronic device 100 to vibrate or shake when activated. Vibration/haptic output device 164 can be activated during an incoming call or message in order to provide an alert or notification to a user of electronic device 100. In one or more embodiments, integrated display 161, audio output devices (or speakers) 163, and vibration/haptic device 164 can generally and collectively be referred to as output devices.

With reference again to FIG. 1B and with continuing reference to FIG. 1A, there is presented another view of electronic device 100 with components enabling electronic device 100 to function as a mobile communication device, within an expanded communication environment 101b. In addition to the functional and operational components already presented by and described within the description of FIG. 1A, FIG. 1B further illustrates expanded communications subsystem 130 with additional communication components and interfaces enabling electronic device 100 to perform wireless communications within an expanded communication environment 101b that includes other devices.

Communications subsystem 130 includes global positioning system (GPS) module 131 that enables electronic device 100 to communicate with and receive GPS location data from GPS satellite(s) 195. In one or more embodiments, GPS module 131 receives geospatial input from GPS broadcasts of time data and location data from GPS satellite(s) 195 to obtain geospatial location information about the physical location of electronic device 100.

In one or more embodiments, controller 110, via communications subsystem 130, performs multiple types of cellular over-the-air (OTA) or non-cellular wireless communication, such as by using a Bluetooth connection or other personal access network (PAN) connection. As shown, communications subsystem 130 includes cellular communication system 132, which includes at least one radio frequency RF front end coupled to one or more antennas. In one or more embodiments, cellular communication system 132 can include a communication module with one or more baseband processors or digital signal processors, one or more modems, and a radio frequency (RF) front end having one or more transmitters and one or more receivers. In one or more embodiments, controller 110, via communications subsystem 130, may communicate via an OTA cellular connection with radio access networks (RANs) over a cellular wireless communication network (CWCN) 175. CWCN 175 can be a terrestrial network and include a plurality of base stations and associated network server(s) 176, in one embodiment. Cellular communication system 132 allows electronic device 100 to communicate wirelessly with CWCN 175 via transmissions of communication signals (represented as lightning bolts) to and from network communication devices, such as base stations or cellular nodes, of CWCN 175. Alternatively, or in addition, CWCN 175 can include a satellite network, and electronic device 100 connects to CWCN 175 using satellite communication system 133. Cellular communication system 132 and satellite communication system 133 enable electronic device 100 to engage in long distance wireless communication capabilities.

In one or more embodiments, communications subsystem 130 includes integrated short range wireless interface chipset 134 having one or more of Wi-Fi transceiver (TxRX) 135, Bluetooth (BT) TxRx 136, near field communication (NFC) transceiver 137, and ultra-wideband (UWB) transceiver 138. In one or more embodiments, the short-range communication devices are not integrated on a single chipset but can be separately provided hardware components. In one or more embodiments, electronic device 100 can communicate wirelessly with external wireless devices, such as a Wi-Fi router of a wireless local area network (WLAN) 178 and/or second electronic device 104, via one or more short-range wireless interface(s). Second electronic device 104 can be a communication device, such as a smartphone, and/or can be similarly configured as electronic device 100. Second user 171 may operate second electronic device 104. In one or more embodiments, electronic device 100 can receive Internet or Wi-Fi based calls, text messages, multimedia messages, and other notifications via a combination of wireless and wired networks (generally networks 182).

In one or more embodiments, networks 182 can include CWCN 175, WLAN 178, and Wide Area Network (WAN) 180, such as the Internet. In one or more embodiments, WAN 180 can enable electronic device 100 to access application servers 190, which can provide a downloadable version of BCE module 125 and/or access to other applications, online transactions, and resources. In one or more embodiments, networks 182 can also include personal area networks (PAN) 184, which are individually created with second devices via one of short-range wireless devices from among Wi-Fi TxRX 135, BT TxRx 136, NFC transceiver 137, and UWB transceiver 138. Example second devices include external display 165, wireless headset 166, and wearable computing device 192. External display 165 can be a stand-alone monitor/display or a display integrated into a second electronic device, such as a laptop computer. In at least one embodiment, connection to the external display 165 can be wired and can include an intermediate connection device, such as a docking station device. In one or more embodiments, wearable computing device 192, such as a smartwatch, fitness tracker, or the like, may be paired with electronic device 100, and provide biometric data such as heart rate, breathing rate, and the like, to the electronic device 100 via the paired communication link.

Electronic device 100 also includes a physical interface 106. Physical interface 106 of electronic device 100 can serve as an input/output data port and can be used as a power supply port that is coupled to charging circuitry 168 which feeds electrical power to device battery 169 to enable recharging of device battery 169 and/or powering of electronic device 100. As a data port, physical interface 106 can enable electronic device 100 to be physically coupled via a cable or docking station port to a second device, such as external display 165.

FIG. 1B also presents additional details of ICD(s) 152 of electronic device 100. Throughout the disclosure, the term image capturing device (ICD) is synonymous with and/or utilized interchangeably with any one of the cameras of electronic device 100. ICD(s) (or cameras) 152 includes front cameras 152a and rear cameras 152b. In one embodiment, each of front cameras 152a and rear cameras 152b are communicatively coupled to ICD controller 116. ICD controller 116 supports the processing of image data from front cameras 152a and rear cameras 152b. Front cameras 152a can include a main camera and a wide-angle camera. Rear ICD(s) can include a main camera, a wide-angle camera, and a telephoto camera. Both sets of cameras 152 include image sensors that can capture images that are within the field of view (FOV) of each respective camera 152. In one or more embodiments, one or more of the cameras can be utilized to enable biometric authentication using facial image and/or iris scan recognition.

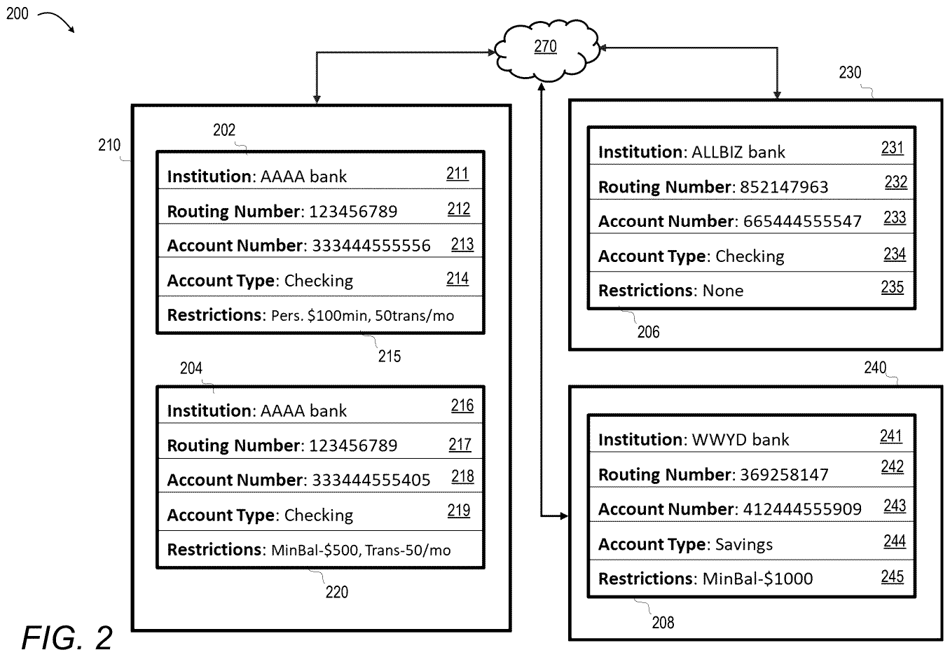

FIG. 2 shows an exemplary environment including multiple financial institutional application servers, with account information stored therein, according to one or more embodiments. Environment 200 includes a server 210 from a first institution that includes two account records for a user, indicated as record 202 and record 204. Each record can include various pieces of metadata. In the example of FIG. 2, record 202 includes an institution name 211, routing number 212, account number 213, account type 214, and restrictions list 215. As indicated in restrictions list 215, the restrictions for the account shown in record 202 includes personal use, a $100 minimum balance requirement, and a limit of 50 transactions per month. Similarly, record 204 for a different account within the same institution includes an institution name 216, which is the same as the institution indicated at 211, routing number 217, which is the same as the routing number indicated at 212, account number 218, account type 219, and restrictions list 220. As indicated in restrictions list 220, the restrictions for the account shown in record 204 include a $500 minimum balance requirement, and a limit of 50 transactions per month. Environment 200 includes a second server 230 from a second institution that includes an account record for a user, indicated as record 206. Record 206 includes an institution name 231, routing number 232, account number 233, account type 234, and restrictions list 235. As indicated in restrictions list 235, there are no restrictions for the account indicated at 233. Environment 200 includes a third server 240 from a third institution that includes an account record for a user, indicated as record 208. Record 208 includes an institution name 241, routing number 242, account number 243, account type 244, and restrictions list 245. As indicated in restrictions list 245, there is a minimum balance of $1000 for the account indicated at 243. The metadata shown in FIG. 2 is exemplary, and other information, such as the name, address, and/or contact information of account holders, may also be stored in data fields within account records.

The servers 210, 230, and 240 may each be similar to servers(s) 190 as indicated in FIG. 1. Each server may include components such as multi-core processors with high clock speeds for parallel processing and handling simultaneous user requests, as well as support for virtualization and encryption instructions to enhance security and efficiency. The servers may further include high-speed network interface cards (NICs) to support fast data transmission between the server and clients, as well as support for redundancy through multiple NICs for failover and load balancing. The servers may include storage such as SSDs (Solid-State Drives) for high-speed storage and quick access to critical banking data, and/or RAID configurations for redundancy and data protection. The servers may utilize a Linux or Windows operating system, web server software, a database management system (DBMS), secure access protocols, authentication protocols such as LDAP (Lightweight Directory Access Protocol), Active Directory, and the like, and/or other components to enable account access and transaction execution from an electronic device such as a smartphone, tablet computer, laptop computer, or other suitable electronic device. In one or more embodiments, the servers 210, 230, and 240 are connected to network 270, which may include a wide-area network (WAN), local-area network (LAN), and/or the Internet, thereby enabling communication with one or more electronic devices, such as electronic device 100 shown in FIG. 1.

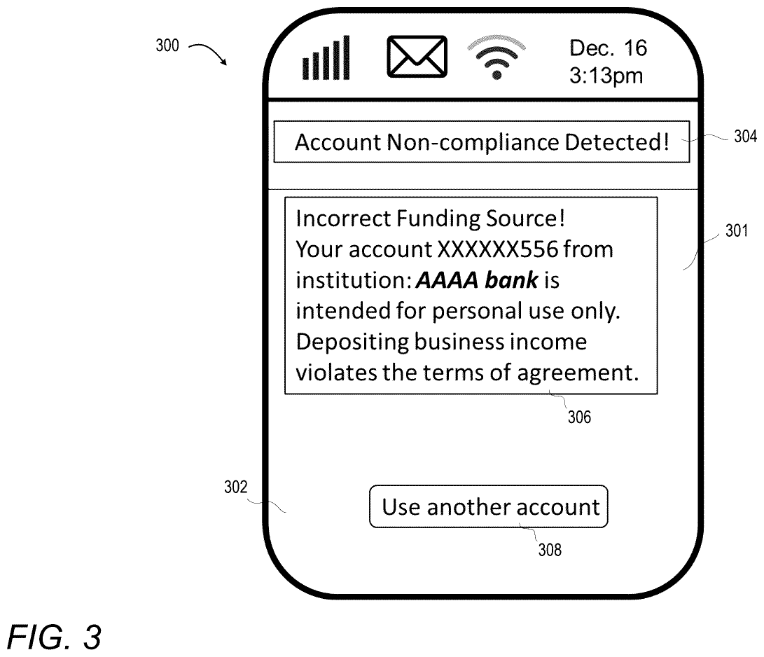

FIG. 3 illustrates an exemplary user interface indicating account non-compliance due to a funding source violation, according to one or more embodiments. Device 300 may be similar to electronic device 100 depicted in FIG. 1A and FIG. 1B. Device 300 includes display 302 on which user interface 301 is rendered and presented. User interface 301 presents an account non-compliance indication 304, along with a data field that includes details of the non-compliance. In the example shown in FIG. 3, the details of the non-compliance indicate that an attempted deposit is of an incorrect funding source for the given account, indicated at 306. The user interface 301 further includes an option 308 that enables a user to conveniently select a different account to use for the attempted deposit. One or more embodiments can include: determining a funding source approved for each user account in each banking institution among the plurality of banking institutions; determining whether there is a mismatch between the approved income source type and an actual income source for a proposed deposit for a selected user account; and in response to determining a funding source mismatch for the selected user account, indicating the selected user account as a non-compliant account, and rendering and presenting an indication of a funding source mismatch for the non-compliant account. The user account is selected from among each user account in each banking institution among the plurality of banking institutions. As shown, an option 308 is provided for the user to select a different one of the user accounts to complete the deposit transaction.

Banks impose restrictions on the types of income that can be deposited into certain accounts, such as limiting business deposits into personal accounts, for regulatory, operational, and financial reasons. These rules are essential for maintaining clarity, ensuring compliance, and protecting both the bank and the account holder. Due to regulations such as Know Your Customer (KYC) and Anti-Money Laundering (AML) regulations, financial institutions are required to monitor account activity for suspicious transactions. Mixing personal and business income in a single account can obscure the source of funds, making compliance with regulations more challenging. Additionally, tax authorities often require clear financial separation between personal and business finances to ensure accurate reporting and compliance with tax laws.

Personal accounts can be designed for lower transaction volumes and fewer deposits. Business accounts, on the other hand, are structured to handle higher volumes and may include additional features (e.g., merchant services or payroll processing). Furthermore, mixing business and personal funds can complicate legal proceedings, particularly if the account holder faces lawsuits or audits. Banks may impose restrictions to avoid being drawn into such disputes.

Many institutions explicitly prohibit using personal accounts for business purposes in their terms and conditions. Violating these terms could result in account closure or freezing of funds. Moreover, blurring the line between personal and business finances makes it harder to track expenses, income, and profits. Mixing personal and business finances can lead to poor financial management and inaccurate reporting, which is especially problematic for small business owners. Disclosed embodiments automate much of the tasks associated with keeping track of both business and personal accounts, thereby mitigating the risk of an account becoming noncompliant due to a funding source violation, especially for small businesses, where the opportunity to inadvertently comingle business and personal funds may exist.

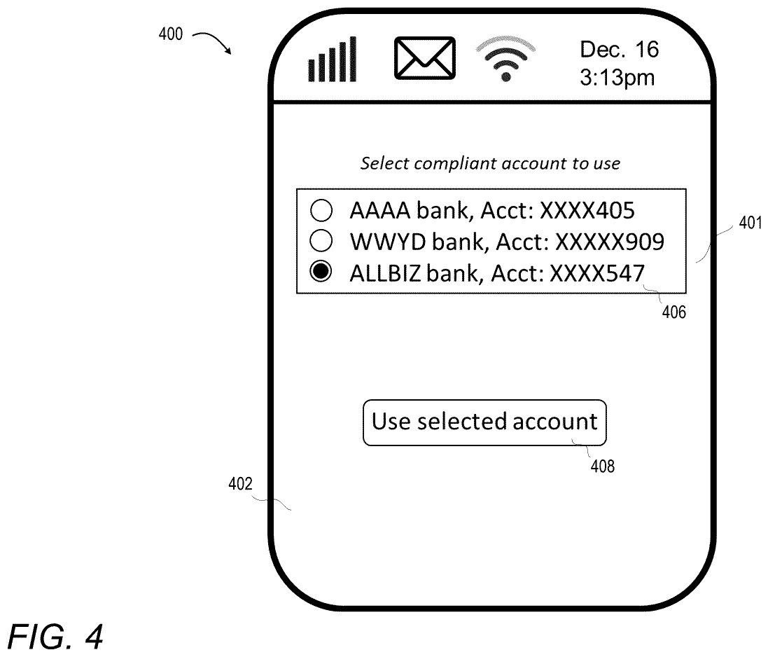

FIG. 4 illustrates an exemplary user interface for suggesting an alternate account to avoid a funding source violation, according to one or more embodiments. Device 400 may be similar to electronic device 100 depicted in FIG. 1 (FIG. 1A and FIG. 1B). Device 400 includes display 402. The example shown in FIG. 4 continues from the example shown in FIG. 3. In response to selection option 308 of FIG. 3, the processor of an electronic device can render and present user interface 401 on the display 402. The user interface 401 includes a data field 406 that can indicate one or more alternate accounts to use. One or more embodiments can identify user accounts that are eligible to use for depositing the given type of income, and include those accounts in data field 406. The user interface 401 further includes an option 408 that enables a user to select the account to use for the attempted deposit.

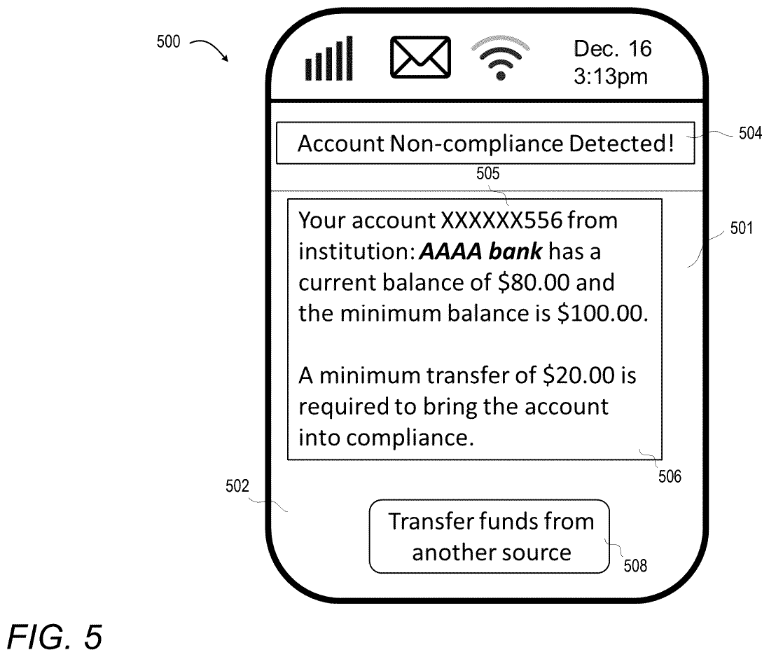

FIG. 5 illustrates an exemplary user interface indicating account non-compliance due to a minimum balance violation, according to one or more embodiments. Device 500 may be similar to electronic device 100 depicted in FIG. 1. Device 500 includes display 502. User interface 501 includes an account non-compliance indication 504, along with a data field 506 that includes details of the non-compliance. In the example shown in FIG. 5, the details of the non-compliance indicate that a current balance for an account has fallen below a minimum balance allowed for the given account. In one or more embodiments, the user interface may further provide proactive warnings regarding an imminent non-compliance condition, such as a pending withdrawal that may cause the account balance to drop below the minimum threshold and place the account in a non-compliance condition once the pending withdrawal is processed. In this way, some disclosed embodiments can proactively prevent non-compliance conditions for financial accounts. The user interface 501 further includes an option 508 that enables a user to conveniently select another account to use as a source account for transferring funds to the non-compliant account 505 indicated in data field 506, in order to bring the account into compliance. In one or more embodiments, the user interface may further include an option of selecting an alternate account to use for making a withdrawal or payment. In this way, disclosed embodiments can guide a user to select an appropriate account for a transaction in order to prevent non-compliance conditions for financial accounts.

Banks and other financial institutions may impose minimum account balance requirements for certain accounts to ensure profitability and cover the costs associated with providing banking services. These requirements also help the bank manage liquidity and maintain financial stability. Maintaining and servicing accounts involves costs, including administrative expenses, customer support, and transaction processing. A minimum balance ensures the bank can offset these costs, especially for accounts with low or no fees. Moreover, the funds held in accounts are often used for lending or investments, generating income for the bank. A minimum balance ensures a consistent level of funds that the bank can leverage for its operations. Additionally, minimum balance requirements are often tied to accounts offering premium benefits, such as higher interest rates, reduced fees, or added services like free checks or waived ATM fees. These accounts require a certain level of profitability to justify the benefits and features provided to the users.

Many financial institutions impose monthly fees if the account balance falls below the minimum. These fees can erode the remaining balance over time. Furthermore, accounts that offer benefits (e.g., higher interest rates, free services, or waived fees) may forfeit those advantages if the minimum balance is not maintained. Additionally, repeated violations of the minimum balance requirement might result in the account being downgraded to a less favorable account type or may even result in the account being closed. Also, for customers with recurring payments or overdrafts, falling below the minimum can lead to additional penalties or cause the account to go negative, triggering overdraft fees. The non-compliance can also potentially cause an account to be closed due to prolonged non-compliance, which may negatively affect a customer's credit score, especially if the closure is reported to credit bureaus. Disclosed embodiments automate the monitoring of minimum balances across multiple accounts of a user, and provide convenient mitigation steps, such as a recommended balance transfer and identification of a source account for the balance transfer, thereby mitigating issues caused by low balance violations for both institutions and customers. Embodiments can include performing a user account compliance status check on each user account that includes a minimum balance check for each account, where the minimum balance check compares a current balance for each user account with a corresponding minimum balance level, and indicating a non-compliance condition in response to the current balance being below the corresponding minimum balance level.

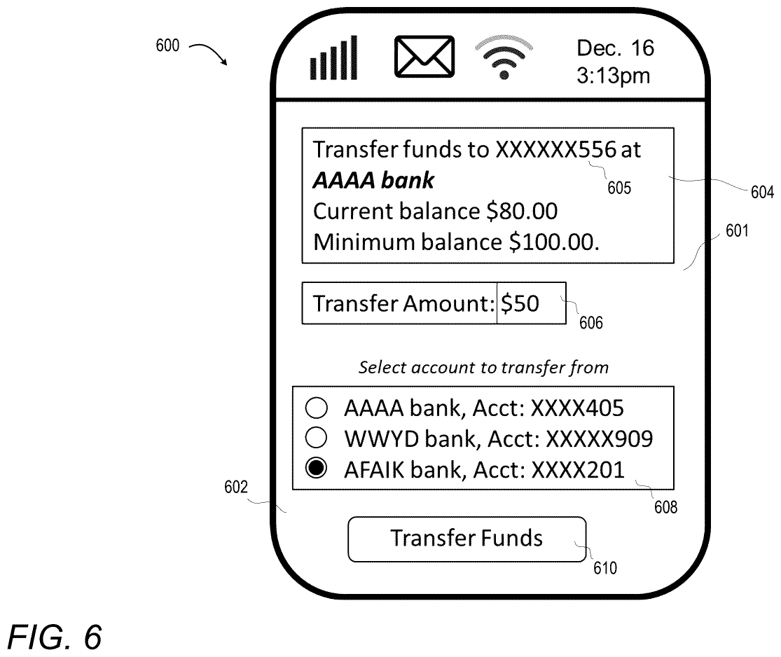

FIG. 6 illustrates an exemplary user interface for balance transfer to transition an account with a balance below a minimum threshold to a compliant state, according to one or more embodiments. Device 600 may be similar to electronic device 100 depicted in FIG. 1A and FIG. 1B. Device 600 includes display 602. The example shown in FIG. 6 continues from the example shown in FIG. 5. In response to selection option 508 of FIG. 5, the processor of an electronic device can render and present user interface 601 on the display 602. The user interface 601 includes a data field 604 that includes details of the balance non-compliance. The user interface 501 further includes a data field 606 that accepts an amount for transfer to the non-compliant account. The user interface 601 further includes data field 608 that shows one or more alternate accounts to use. One or more embodiments can identify user accounts that have sufficient funds for making the transfer, and include those accounts in data field 608. The user interface 601 further includes an option 610 that enables a user to select the account to use for the transfer to make the account 605 indicated in data field 604 compliant. One or more embodiments can include rendering and presenting a transfer window on the display with selectable options for a user to determine an amount for a transfer and whether to proceed with the transfer.

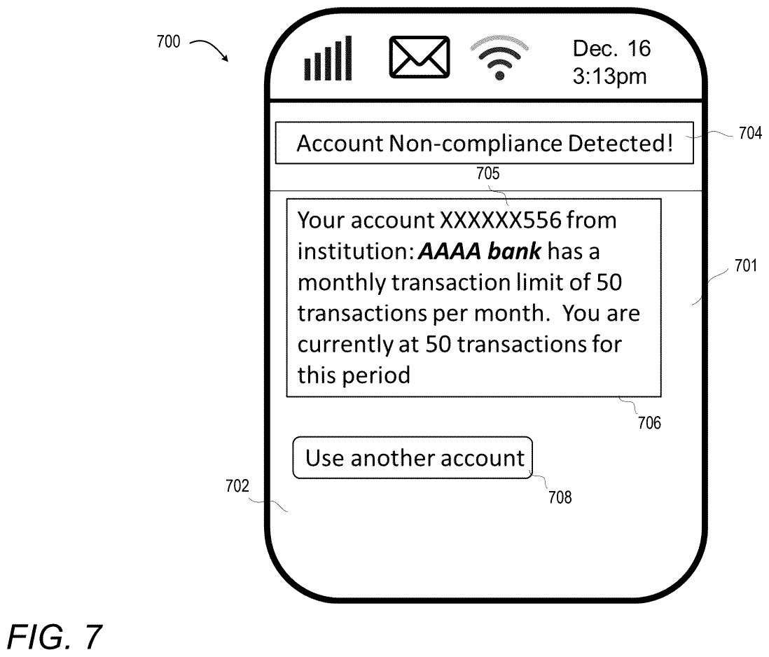

FIG. 7 illustrates an exemplary user interface indicating account non-compliance due to a transaction limit violation, according to one or more embodiments. Device 700 may be similar to electronic device 100 depicted in FIG. 1. Device 700 includes display 702. User interface 701 includes an account non-compliance indication 704, along with a data field 706 that includes details of the non-compliance. In the example shown in FIG. 7, the details of the non-compliance indicate that a number of transactions per month is at its allowable limit. In one or more embodiments, other time periods instead of, or in addition to, a monthly time period may be used. Examples can include, but are not limited to, a weekly time period, daily time period, quarterly time period, annual time period, and so on. The user interface 701 further includes an option 708 that enables a user to select an alternate account to use for the transaction, to avoid exceeding the transaction limit on the account 705 indicated in data field 706. The user interface 701 further includes an option 708 that enables a user to select the account to use for the transfer.

Banks and other financial institutions may impose monthly transaction limits on certain accounts for regulatory, operational, or financial reasons. These limits may be found on specific types of accounts, such as savings accounts or accounts offering specific benefits like higher interest rates or lower fees. Such transaction limits can serve to encourage saving. Transaction limits encourage customers to use savings accounts for long-term savings rather than frequent transactions, fostering better money management habits. Transaction limits can also help institutions to maintain required reserves. Moreover, in general, every transaction incurs processing costs for the bank. Imposing limits helps reduce these costs, particularly for accounts with low fees or no charges. Exceeding transaction limits may result in per-transaction fees, reducing the cost-effectiveness of the account. Moreover, some institutions may impose penalties, reducing or eliminating any interest earned for that period. Disclosed embodiments automate many aspects of the burden of monitoring activity and tracking transactions to avoid the adverse effects of exceeding transaction limits. One or more embodiments can include: retrieving an established transaction limit per unit time period for each user account in each banking institution among the plurality of banking institutions; determining a current number of transactions for each user account in each banking institution among the plurality of banking institutions; comparing the current number of transactions per unit time period for each user account with a respective preestablished number of transactions per unit time period for a corresponding user account; and in response to determining that a current number of transactions at a first user account is at or above the respective preestablished number of transactions for the first user account, indicating the first user account as a non-compliant account, and rendering and presenting an indication of a transaction limit alert for the non-compliant account.

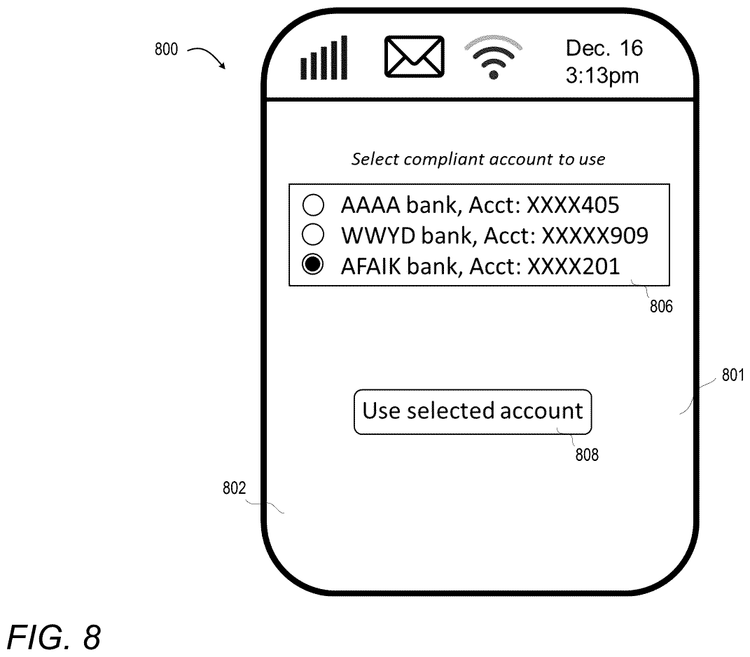

FIG. 8 illustrates an exemplary user interface for suggesting an alternate account to avoid a transaction limit violation, according to one or more embodiments. Device 800 may be similar to electronic device 100 depicted in FIG. 1. Device 800 includes display 802. The example shown in FIG. 8 continues from the example shown in FIG. 7. In response to selection option 708 of FIG. 7 the processor of an electronic device can render and present user interface 801 on the display 802. The user interface 801 includes data field 806 that can indicate one or more compliant accounts to use as an alternative account for a transaction. The user interface 801 further includes an option 808 that enables a user to select the alternate account to use for the transaction to avoid exceeding the transaction limit. One or more embodiments can identify user accounts that have available (or unlimited) transaction quota and include those accounts in data field 706. One or more embodiments can include: identifying at least one user account in at least one banking institution among the plurality of banking institutions that has a current number of transactions that is less than a transaction limit level for the identified at least one user account; and including in the non-compliance alert message, an option to use the identified at least one user account instead of the non-compliant account.

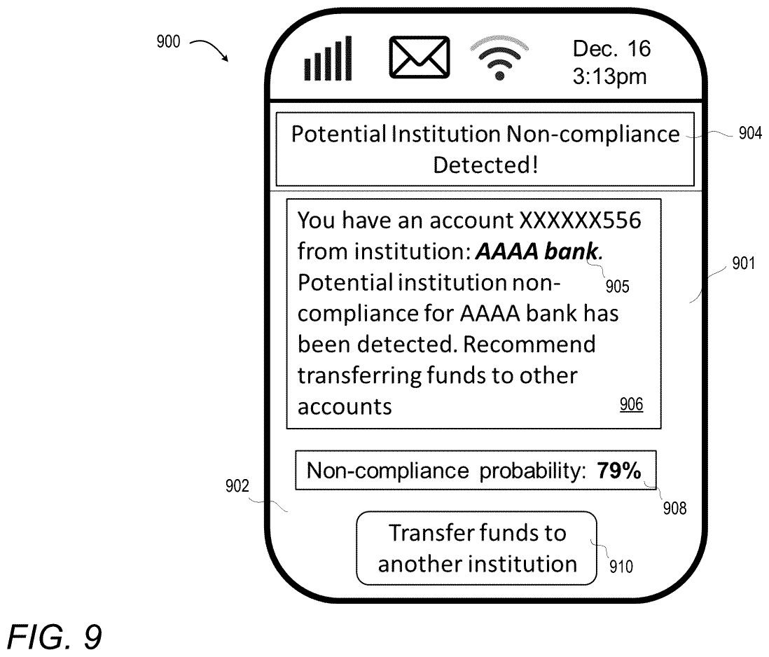

FIG. 9 illustrates an exemplary user interface for warning a user about institutional non-compliance, according to one or more embodiments. Device 900 may be similar to electronic device 100 depicted in FIG. 1. Device 900 includes display 902 On which user interface 901 is presented. User interface 901 includes a potential institution account non-compliance indication 904, along with a data field 906 that includes details of the non-compliance. One or more embodiments can include performing a banking institution compliance status check performed for each of the plurality of banking institutions. In the example shown in FIG. 9, the details of the non-compliance indicate that the institution 905 indicated in data field 906 is potentially in a non-compliant state. The user interface 901 further includes data field 908 that indicates a non-compliance probability. The user interface 901 further includes an option 910 that enables a user to conveniently select a different institution to use for transferring funds out of the institution 905 indicated in data field 906.

Identifying signs that a financial institution might be headed toward a non-compliant state is important for stakeholders, customers, and regulators. Disclosed embodiments can scrape, monitor, and analyze publicly available information, which can reveal warning signs. The scraped information can include news regarding repeated fines, sanctions, and/or warnings from financial regulatory bodies against a particular institution. The sources of information can include publicly available information such as annual reports, press releases, and/or news articles. Other criteria that can be used in a determination of a probability that a financial institution might be headed toward a non-compliant state can include news indicating sudden resignations of key compliance officers and/or board members, whistleblower allegations related to compliance failures, and/or reports of internal investigations and/or audits uncovering violations. Other criteria can include financial criteria such as indicators of poor financial health and/or significant losses reported in earnings statements, downgrades in credit ratings by agencies such as Moody's, S&P, or Fitch, and/or unexplained delays in publishing financial statements or audits. Other criteria can include crowdsourced information. The crowdsourced information can include customer feedback. The information that indicates a potential non-compliant state of a financial institution can include high volumes of unresolved customer complaints on forums, review sites, or social media, and/or specific patterns in the complaints, such as issues with account freezes, unexplained charges, and/or privacy breaches. Other information may be used instead of, or in addition to, the aforementioned information in one or more embodiments.

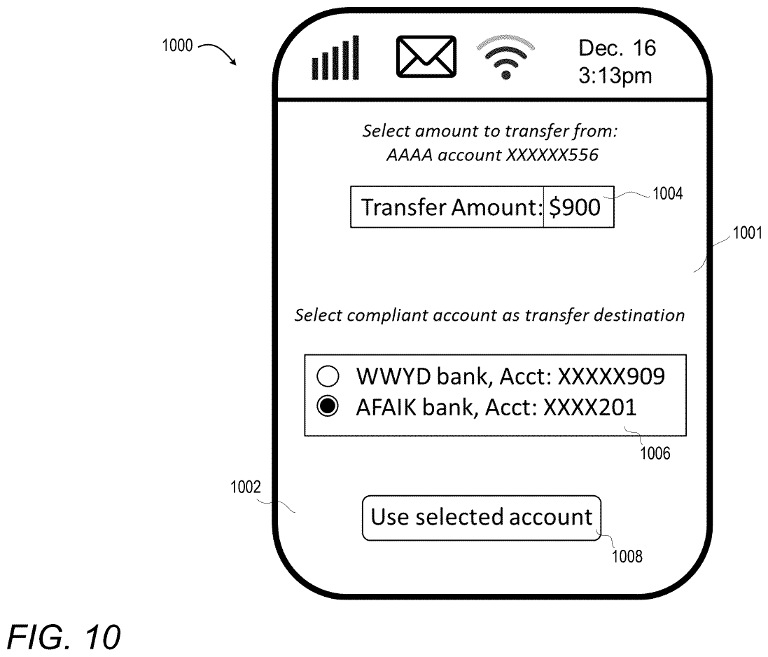

FIG. 10 illustrates an exemplary user interface for suggesting an alternate institution to avoid institutional non-compliance, according to one or more embodiments. Device 1000 may be similar to electronic device 100 depicted in FIG. 1. Device 1000 includes display 1002. When it is determined that an institution has a likelihood to enter a non-compliant state, such as indicated in FIG. 9, the user interface 1001 can enable a user to transfer funds to a compliant account at another institution, to allow uninterrupted access to the funds. One or more embodiments can identify user accounts from other institutions that do not currently have a high likelihood of entering a non-compliant state and include those accounts in data field 1006. The user interface 1001 includes data field 1004 that accepts an amount to be transferred. The user interface 1001 further includes data field 1006 that includes one or more compliant accounts that can serve as a destination account for a transfer of the funds indicated in data field 1004. The user interface 1001 further includes option 1008 that enables a user to select the account to use for the transfer.

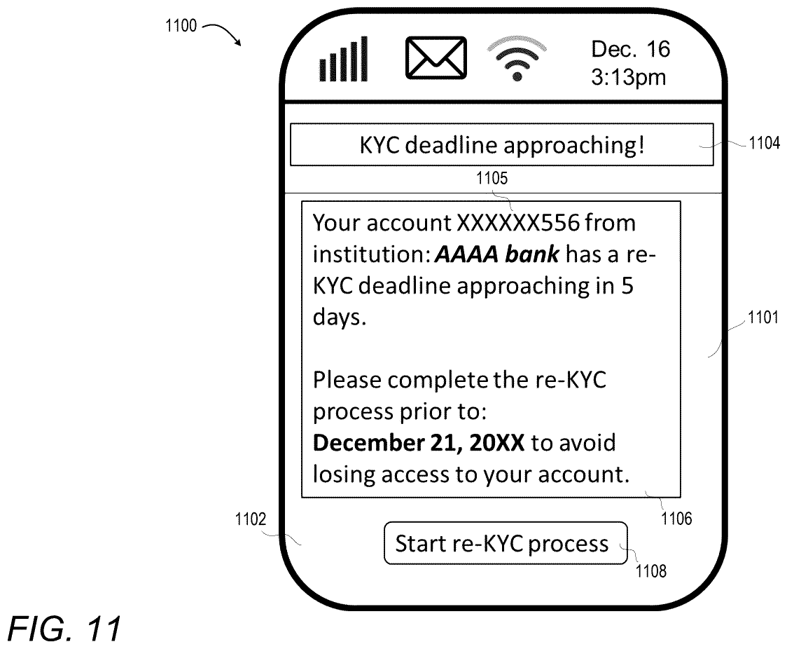

FIG. 11 illustrates an exemplary user interface for warning a user about an approaching Know-Your-Customer (KYC) deadline, according to one or more embodiments. Device 1100 may be similar to electronic device 100 depicted in FIG. 1. Device 1100 includes display 1102. User interface 1101 is rendered and presented on display 1102. User interface 1101 includes a KYC deadline warning indication 1104, along with a data field 1106 that includes details of the KYC deadline expiration. The user interface 1101 further includes an option 1108 that enables a user to initiate a re-KYC process in order to preserve the account 1105 in a state of compliance.

KYC (Know Your Customer) is a critical component of banking regulations, designed to verify the identity of customers and assess potential risks of illegal activities such as money laundering, fraud, or financing of terrorism. By requiring customers to provide valid and accurate identification, KYC helps banks detect and prevent money laundering, fraud, and other illicit financial activities. In many jurisdictions, banks are mandated by law to implement KYC procedures to comply with anti-money laundering (AML) and counter-terrorism financing (CTF) regulations. Failure to comply can result in hefty fines, loss of reputation, and/or revocation of banking licenses. Through KYC, banks can assess and monitor the financial behavior of their customers. Thus, KYC enables the identification of high-risk accounts and ensures appropriate measures are taken to mitigate risks.

Allowing KYC information to expire may result in violations, penalties, and/or freezing of assets. Moreover, outdated KYC information may prevent banks from accurately assessing customer risk. Changes in customer profiles, such as new sources of income or changes in residency, could alter risk levels and necessitate adjustments in the bank's monitoring practices. Furthermore, expired KYC information can lead to account freezes, disruptions in transactions, or denial of banking services. Disclosed embodiments promote up-to-date KYC information, thus preventing inconvenience for users. One or more embodiments can include: retrieving a know your customer (KYC) expiration date for each user account in each banking institution among the plurality of banking institutions; determining a current number of days until each KYC expiration date; comparing the current number of days until each KYC expiration date with a predetermined threshold value; and in response to determining that the current number of days for one or more of the KYC expiration dates is less than the predetermined threshold value, rendering and presenting a reminder to complete a re-KYC process.

In general, disclosed embodiments may utilize a combination of application programming interfaces (APIs), secure protocols, and robust backend processes to integrate banking functions across multiple accounts and institutions in a mobile application. One or more embodiments may utilize account aggregation APIs, including Open Banking APIs, such as those provided by Plaid, Yodlee, TrueLayer, or the like. The APIs may access one or more servers associated with one or more financial institutions (e.g., such as application server(s) 190 of FIG. 1A). Disclosed embodiments may also support ACH and wire transfer APIs. Additionally, disclosed embodiments may provide account linking and authentication capabilities, utilizing serves such as OAuth2 authentication, SSH, asymmetric encryption techniques, and so on. Disclosed embodiments may utilize a rules engine that enables users to create rules such as “warn if balance falls below $500” or “transfer $150 from savings if checking balance drops below $1,000.” In one or more embodiments, the rules engine may utilize AI (machine learning) to derive and/or adjust rules based on a customer usage history. One or more embodiments may utilize machine learning models to predict potential issues. As an example, disclosed embodiments may warn a user about the possibility of incurring overdraft fees based on upcoming bills and current balance. One or more embodiments can include: using a machine learning model, where the machine learning model is trained in at least one of financial anomaly detection, sentiment analysis, credit risk modeling, fraud detection, contagion risk evaluation, and operational risk evaluation.

One or more embodiments may utilize a microservices architecture to provide separate services for data aggregation, transfer operations, and rule processing, to enable scalability. One or more embodiments may utilize storage architectures such as relational (e.g., PostgreSQL) and/or NoSQL (e.g., MongoDB) databases for managing user profiles, rules, transaction logs, and the like. Thus, disclosed embodiments can leverage Open Banking APIs, strong rule-based automation, and secure, scalable architecture, to deliver seamless integration of banking functions across multiple institutions while maintaining a high level of security and user satisfaction.

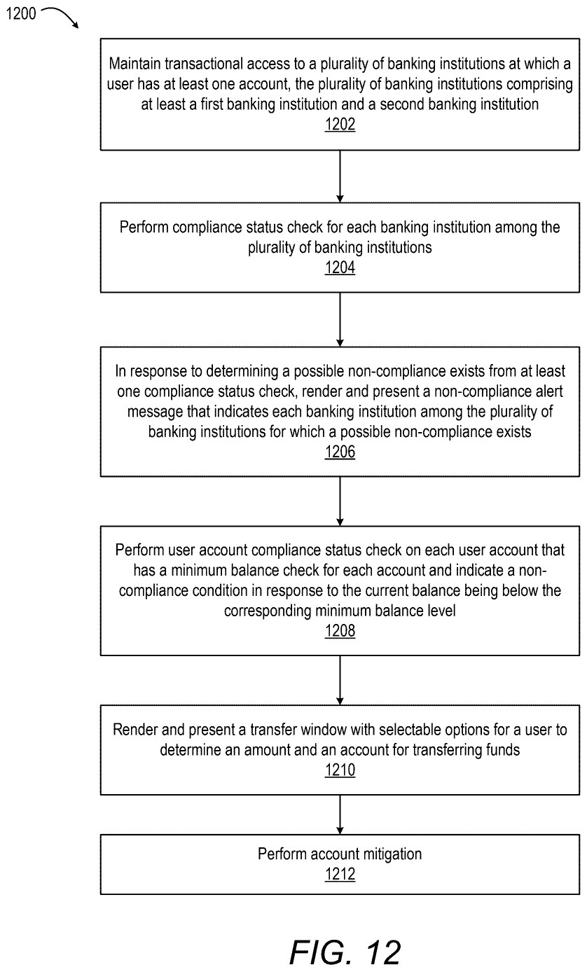

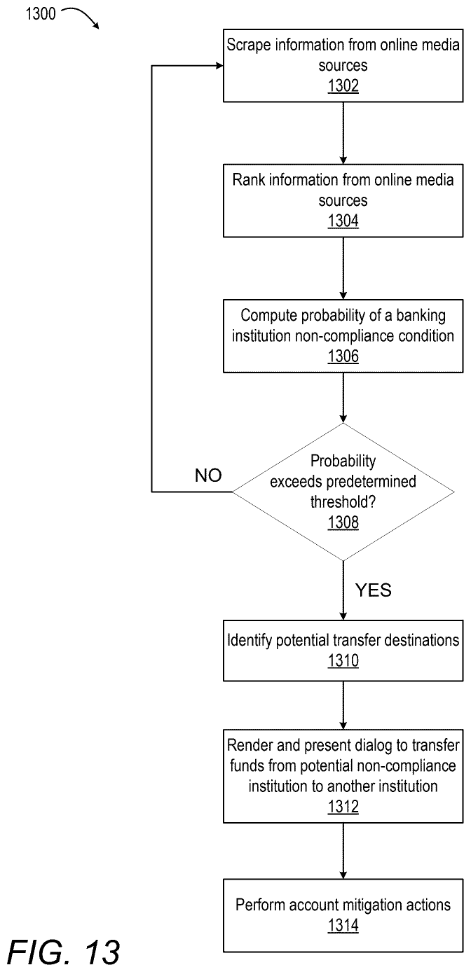

Referring now to the flowcharts presented by FIG. 12-FIG. 13, the descriptions of the methods in FIG. 12-FIG. 13 are provided with general reference to the specific components and features illustrated within the preceding FIGS. 1-11 . Specific components referenced in the methods of FIG. 12-FIG. 13 may be identical or similar to components of the same name used in describing preceding FIGS. 1-11 . In one or more embodiments, processor 112 (FIG. 1A) configures electronic device 100 (FIG. 1A) to provide the described functionality of the methods of FIG. 12-FIG. 13 by executing program code for one or more modules or applications provided within system memory 120 of electronic device 100, including banking compliance evaluation (BCE) module 125.

FIG. 12 depicts a flowchart of a computer-implemented method for banking compliance monitoring, according to one or more embodiments. The method 1200 starts at block 1202, where transactional access to a plurality of banking institutions at which a user has at least one account is maintained. The plurality of banking institutions includes at least a first banking institution and a second banking institution. The transactions can include withdrawals, deposits, inter-bank transfers, wire transfers, interest payments, and so on. The method 1200 continues to block 1204 where a compliance status check for each banking institution among the plurality of banking institution is performed. The compliance status check can include scraping websites and/or other public sources of data for information regarding a particular financial institution. The method 1200 continues to block 1206 where, in response to determining a possible non-compliance exists from at least one compliance status check, a non-compliance alert message is rendered and presented on an electronic device. The non-compliance alert message indicates each banking institution among the plurality of banking institutions for which a possible non-compliance exists. The method 1200 continues to block 1208 where a user account compliance status check is performed on each user account that has a minimum balance check for each account, and a non-compliance condition is indicated in response to the current balance being below the corresponding minimum balance level. The method 1200 then continues to block 1210, where a transfer window with selectable options for a user to determine an amount and an account for transferring funds is rendered and presented. The method 1200 then continues to block 1212, where account mitigation is performed. In one or more embodiments, the account mitigation can include transfer of funds, selection of an alternate account to use for a transaction, and/or other suitable mitigation actions. In one or more embodiments, the account mitigation may be performed automatically. Thus, disclosed embodiments, including the method 1200, can check for both institutional non-compliance and user non-compliance, and issue warnings and recommendations accordingly.

FIG. 13 depicts a flowchart of a computer-implemented method providing additional embodiments for banking compliance monitoring, according to one or more embodiments. The method 1300 starts at block 1302, where information is scraped from online media sources. Disclosed embodiments can be configured to scrape information from online sites to gather insights about the banking industry. The scraped information can include data such as financial performance, customer reviews, compliance updates, interest rates, and/or industry trends. The scraping can include obtaining interest rates, fees, and/or account terms from product website pages for various financial institutions. The scraping can further include customer reviews and ratings from review sites. The scraping can further include financial reports and/or press releases from bank and/or industry news sections. The data that is scraped can include HTML data, XML data, JSON data, JavaScript-rendered content, and/or other suitable types of data. One or more embodiments may utilize Python and associated libraries to scrape information and/or analyze the scraped information. In embodiments, each piece of information may be given a weight. The respective weights of each piece of information may be added or otherwise applied to compute a probability of non-compliance based on the scraped information.

The method 1300 continues to block 1304, where the information from online media sources is ranked. Ranking information from online sources can include assessing its quality, reliability, and relevance. Disclosed embodiments provide a systematic approach that promotes data which is both actionable and credible. The criteria for ranking sources can include a highest tier of sources, which includes an authority status, in which official sources such as government or regulatory websites (e.g., FDIC, Federal Reserve, SEC) generally hold the highest weight. The next tier of sources includes prominent financial publications (e.g., Wall Street Journal, Bloomberg) and established industry blogs, which also rank high for expertise and credibility. The next tier of sources can include customer reviews and social media posts, which rank lower due to potential bias or lack of verification. In one or more embodiments, higher scores are assigned to sources with verified credentials, such as authenticated bank websites or published financial reports. Moreover, disclosed embodiments can evaluate whether past information from the source was correct and aligned with actual outcomes. In some embodiments, sources with a track record of providing verifiable and consistent data are ranked higher. Embodiments may further include cross-checking the same information across multiple trusted sources. Consistent data across multiple sources results in a higher ranking. One or more embodiments can include: scraping information from one or more online media sources; and ranking the one or more online media sources based on a source category, where the source category can include one from a group comprising a regulatory site, a media site, and a social media site, where the scraped information, in conjunction with the ranking for the one or more online media sources, is used to determine a probability of a banking institution non-compliance condition. Other criteria may be used for ranking information instead of, or in addition to, the aforementioned criteria, in one or more embodiments.

The method 1300 continues to block 1306, where the probability of a banking institution non-compliance condition is computed. In embodiments, the probability of non-compliance can be computed as a function of the number of sources containing information about a given financial institution, the rank of the sources, and/or other information. The method 1300 continues to block 1308, where a check is made to determine if the probability of non-compliance for an institution exceeds a predetermined threshold (e.g., 77 percent). If, at block 1308, the computed probability exceeds the predetermined threshold, then the method 1300 continues to block 1310, where potential transfer destinations are identified. The potential transfer destinations can include user accounts held by the user at other financial institutions. The identification of potential transfer destinations can include evaluating current balances, transaction limits, and/or other criteria corresponding to accounts associated with the user. The method 1300 then continues to block 1312, where a dialog to transfer funds from potential non-compliance institution to another institution is rendered and presented, such as depicted in FIG. 10. The method 1300 then continues to block 1314, where account mitigation actions are performed, such as transferring funds from one account to another account to put an account in a compliant state, transferring funds from an account from a potentially non-compliant institution to an account at a different, compliant institution, selecting an alternate account to use for a transaction, and/or other mitigation actions. In one or more embodiments, the mitigation actions may be performed automatically. If, at block 1308, it is determined that the probability of non-compliance of a financial institution does not exceed a predetermined threshold, then the method 1300 returns to block 1302 to continue scraping information from online media sources on a periodic basis, such as a daily basis, twice daily, or other suitable scraping interval, to continue monitoring of financial institutions.

The flowcharts, sequences, and configurations presented herein are provided solely for illustrative purposes and are exemplary in nature. These embodiments are not intended to be limiting and may include variations with more, fewer, and/or alternative options, sequences, or features as would be apparent to those skilled in the art.

As can now be appreciated, disclosed embodiments provide techniques for banking compliance monitoring that checks both institutions and user accounts for non-compliance or potential non-compliance. Advantages of disclosed embodiments can include real-time monitoring that provides continuous tracking of account and institutional compliance to ensure prompt detection of potential issues, minimizing the risk of penalties and/or legal consequences. Furthermore, in one or more embodiments, users are proactively alerted to potential non-compliance (e.g., low balances, transaction limit breaches, account usage violations) before the potential non-compliance becomes a serious problem. On the institutional side, disclosed embodiments flag institutions showing signs of regulatory lapses (e.g., delayed filings, negative news, or violations) to help users make informed decisions about where to keep their assets. With disclosed embodiments, users can feel reassured knowing their financial activities are being monitored for compliance, reducing stress over inadvertent violations. Moreover, disclosed embodiments can provide actionable steps, such as transferring funds to or from an account in order to safeguard user funds. Thus, disclosed embodiments can provide a banking compliance monitoring system that tracks both institutional and user compliance, thereby serving as a valuable tool for safeguarding financial health. By offering real-time monitoring, actionable alerts, practical recommendations, and/or automatic triggering and/or initiating of mitigation steps, disclosed embodiments enhance trust, reduce risks, and simplify compliance management.

In the above-described methods, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined primarily by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals, but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. An electronic device comprising:
a display;
a communications subsystem enabling the electronic device to communicatively connect to a network comprising a plurality of second electronic devices;
a memory having stored thereon a banking compliance evaluation (BCE) module; and
at least one processor coupled to the display, the communications subsystem, and the memory and which processes program code of the BCE module, the at least one processor configured to cause the electronic device to:
maintain transactional access to a plurality of banking institutions at which a user has at least one account, the plurality of banking institutions comprising at least a first banking institution and a second banking institution;
perform a compliance status check for each banking institution among the plurality of banking institutions; and
in response to determining a possible non-compliance exists from at least one compliance status check, render and present a non-compliance alert message that indicates each banking institution among the plurality of banking institutions for which a possible non-compliance exists.

2. The electronic device of claim 1, wherein to perform the compliance status check, the at least one processor is further configured to:
perform a user account compliance status check on each user account that includes a minimum balance check for each account, wherein the minimum balance check compares a current balance for each user account with a corresponding minimum balance level; and
indicate a non-compliance condition in response to the current balance being below the corresponding minimum balance level.

3. The electronic device of claim 2, wherein the at least one processor is configured to cause the electronic device to:
render and present on the display a transfer window on the display with selectable options for a user to determine an amount for a transfer and whether to proceed with the transfer.

4. The electronic device of claim 1, wherein to perform the compliance status check, the at least one processor is further configured to:
retrieve a know your customer (KYC) expiration date for each user account in each banking institution among the plurality of banking institutions;
determine a current number of days until each KYC expiration date;
compare the current number of days until each KYC expiration date with a predetermined threshold value; and
in response to determining that the current number of days for one or more of the KYC expiration dates is less than the predetermined threshold value, render and present on the display a reminder to complete a re-KYC process.

5. The electronic device of claim 1, wherein to perform the compliance status check, the at least one processor is further configured to:
retrieve an established transaction limit per unit time period for each user account in each banking institution among the plurality of banking institutions;
determine a current number of transactions for each user account in each banking institution among the plurality of banking institutions;
compare the current number of transactions per unit time period for each user account with a respective preestablished number of transactions per unit time period for a corresponding user account; and
in response to determining that a current number of transactions at a first user account is at or above the respective preestablished number of transactions for the first user account, indicate the first user account as a non-compliant account, and render and present on the display an indication of a transaction limit alert for the non-compliant account.

6. The electronic device of claim 5, wherein the at least one processor is further configured to:
identify at least one user account in at least one banking institution among the plurality of banking institutions that has a current number of transactions that is less than a transaction limit level for the at least one user account; and
include in the non-compliance alert message, an option to use the identified at least one user account instead of the non-compliant account.

7. The electronic device of claim 2, wherein to perform the user account compliance status check, the at least one processor is further configured to:
determine a funding source approved for each user account in each banking institution among the plurality of banking institutions;
determine whether there is a mismatch between the approved funding source and an actual funding source for a proposed deposit for a selected user account from among each user account in each banking institution among the plurality of banking institutions; and
in response to determining a funding source mismatch for the selected user account, indicate the selected user account as a non-compliant account, and render and present on the display an indication of a funding source mismatch for the non-compliant account.

8. The electronic device of claim 1, wherein the compliance status check comprises a banking institution compliance status check performed for each of the plurality of banking institutions.

9. The electronic device of claim 8, wherein to perform the banking institution compliance status check, the at least one processor is further configured to:
scrape information from one or more online media sources; and
rank the one or more online media sources based on a source category, wherein the source category can include one from a group comprising a regulatory site, a media site, and a social media site, wherein the scraped information, in conjunction with the ranking for the one or more online media sources, is used to determine a probability of a banking institution non-compliance condition.

10. The electronic device of claim 8, wherein to perform the banking institution compliance status check, the at least one processor is further configured to use a machine learning model, wherein the machine learning model is trained in at least one of financial anomaly detection, sentiment analysis, credit risk modeling, fraud detection, contagion risk evaluation, and operational risk evaluation.

11. A method comprising:
maintaining, on an electronic device comprising a display, transactional access to a plurality of banking institutions at which a user has at least one account, the plurality of banking institutions comprising at least a first banking institution and a second banking institution;
performing a compliance status check for each banking institution among the plurality of banking institutions; and
in response to determining a possible non-compliance exists from at least one compliance status check, rendering and presenting a non-compliance alert message that indicates each banking institution among the plurality of banking institutions for which a possible non-compliance exists.

12. The method of claim 11, further comprising performing a user account compliance status check on each user account that includes a minimum balance check for each account, wherein the minimum balance check compares a current balance for each user account with a corresponding minimum balance level and indicates a non-compliance condition in response to the current balance being below the corresponding minimum balance level.

13. The method of claim 12, further comprising rendering and presenting a transfer window on the display with selectable options for a user to determine an amount for a transfer and whether to proceed with the transfer.

14. The method of claim 12, further comprising:
retrieving a know your customer (KYC) expiration date for each user account in each banking institution among the plurality of banking institutions;
determining a current number of days until each KYC expiration date;
comparing the current number of days until each KYC expiration date with a predetermined threshold value; and
in response to determining that the current number of days for one or more of the KYC expiration dates is less than the predetermined threshold value, rendering and presenting a reminder to complete a re-KYC process.

15. The method of claim 11, further comprising:
retrieving an established transaction limit per unit time period for each user account in each banking institution among the plurality of banking institutions;
determining a current number of transactions for each user account in each banking institution among the plurality of banking institutions;
comparing the current number of transactions per unit time period for each user account with a respective preestablished number of transactions per unit time period for a corresponding user account; and
in response to determining that a current number of transactions at a first user account is at or above the respective preestablished number of transactions for the first user account, indicating the first user account as a non-compliant account, and rendering and presenting an indication of a transaction limit alert for the non-compliant account.

16. The method of claim 15, further comprising:
identifying at least one user account in at least one banking institution among the plurality of banking institutions that has a current number of transactions that is less than a transaction limit level for the identified at least one user account; and
including in the non-compliance alert message, an option to use the identified at least one user account instead of the non-compliant account.

17. The method of claim 11, further comprising:
determining a funding source approved for each user account in each banking institution among the plurality of banking institutions;
determining whether there is a mismatch between the approved funding source and an actual funding source for a proposed deposit for a selected user account from among each user account in each banking institution among the plurality of banking institutions; and
in response to determining a funding source mismatch for the selected user account, indicating the selected user account as a non-compliant account, and rendering and presenting an indication of a funding source mismatch for the non-compliant account.

18. The method of claim 11, further comprising performing a banking institution compliance status check performed for each of the plurality of banking institutions.

19. A computer program product comprising a non-transitory computer readable medium having program instructions that when executed by a processor of an electronic device, configure the electronic device to perform functions comprising:
maintaining transactional access to a plurality of banking institutions at which a user has at least one account, the plurality of banking institutions comprising at least a first banking institution and a second banking institution;
performing a compliance status check for each banking institution among the plurality of banking institutions; and
in response to determining a possible non-compliance exists from at least one compliance status check, rendering and presenting a non-compliance alert message that indicates each banking institution among the plurality of banking institutions for which a possible non-compliance exists.

20. The computer program product of claim 19, further comprising program instructions for:
determining a current number of transactions for each user account in each banking institution among the plurality of banking institutions;
comparing the current number of transactions per unit time period for each user account with a respective preestablished number of transactions per unit time period for a corresponding user account; and
in response to determining that a current number of transactions at a first user account is at or above the respective preestablished number of transactions for the first user account, indicating the first user account as a non-compliant account, and rendering and presenting an indication of a transaction limit alert for the non-compliant account.
